(19) United States
(12) Patent Application Publication
(10) Pub. No.: US 2005/0066776 A1
(43) Pub. Date: Mar. 31, 2005

(54) Damaged spark/glow plug removal tool

(76) Inventors: Gregory E. Ward, Findlay, OH (US); Michael S. Lynch, Fostoria, OH (US)

Correspondence Address: Honeywell International Inc., 101 Columbia Road, P.O. Box 2245, Morristown, NJ, 07962, US

(21) Appl. No.: 10/675,821

(22) Filed: Sep. 30, 2003

(51) Int. Cl. B25B 13/50

(52) U.S. Cl. 81/53.2

(57) ABSTRACT

A tool for removal of a damaged spark/glow plug has an electrode end, an electrical connector end, and an insulator therebetween. The plug further has a damaged or missing wrench-engaging member having a pre-damaged width-across-corners diameter and disposed between the insulator and the electrode end. The plug has a body adjacent the wrench-engaging member or a position previously occupied by the wrench engaging member. The body has a reduced diameter from the wrench-engaging member width-across-corners diameter. The tool includes a plug engaging end having an interior surface having a geometry adapted to cut into the body of the spark/glow plug. The tool further includes an end opposed to the plug engaging end and adapted to be matingly engageable with a wrench.

### BACKGROUND OF THE INVENTION

The present invention relates generally to spark/glow plugs, and more particularly to the removal of damaged spark/glow plugs from a cylinder head in an engine.

Historically, spark plugs were changed at regular intervals during routine tune-ups. Advancing technology in the areas of fuel consumption, fuel management, and spark plug composition have dramatically increased the length of time between spark plug replacements. Presently, it is not uncommon for a spark plug installed in an automotive gasoline-fueled internal combustion engine to remain in service for over 100,000 miles.

In prolonged service at high temperature, threaded interfaces may tend to require a high initial torque to break the threads free. Another consequence of prolonged service at high temperature may be embrittlement of metallic structures and reduction of the ultimate tensile strength of the metal that forms the body of the spark plug. Corrosion may be another time and temperature related factor that may reduce the strength of the spark plug body.

A spark plug is generally removed from a cylinder head by operatively engaging a suitable wrench with a hex member that is incorporated with/into the shell of the spark plug.

However, if increased removal torque induces stresses that exceed the decreased strength of the spark plug body, the hex flats may shear off, or the shell may fracture, and the hex member (and/or other portions of the plug) may fall off entirely.

Removal of a damaged spark plug should generally be approached carefully, as one would want to avoid pushing broken pieces of the spark plug into the combustion chamber. For the above reasons, damaged spark plug removal has become increasingly difficult. In some cases, the cylinder head may unfortunately need to be removed to extract the damaged spark plug.

Removal of damaged glow plugs may encompass similar concerns.

### SUMMARY OF THE INVENTION

The present invention substantially solves the concerns enumerated above by providing a tool for removal of a damaged spark/glow plug having an electrode end, an electrical connector end, and an insulator therebetween. The plug further has a damaged or missing wrench-engaging member having a pre-damaged width-across-corners diameter and disposed between the insulator and the electrode end. The plug has a body adjacent the wrench-engaging member or a position previously occupied by the wrench engaging member. The body has a reduced diameter from the wrench-engaging member width-across-corners diameter. The tool includes a plug engaging end having an interior surface having a geometry adapted to cut into the body of the spark/glow plug. The tool further includes an end opposed to the plug engaging end and adapted to be matingly engageable with a wrench.

### BRIEF DESCIPTION OF THE DRAWINGS

Objects, features and advantages of the present invention will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1A is a perspective view of an embodiment of the present invention;

FIG. 1B is a reverse perspective view of the embodiment of FIG. 1A;

FIG. 2A is a perspective view of an alternate embodiment of the present invention;

FIG. 2B is a reverse perspective view of the embodiment of FIG. 2A;

FIG. 3A is a perspective view of a damaged spark plug (with the wrench-engaging member, insulator and electrical connector end broken off) inserted into the embodiment of the present invention as shown in FIG. 1A;

FIG. 3B is an exploded perspective view of the view of FIG. 3A, showing the spline indentations on the body of the spark plug;

FIG. 4A is a perspective view of a damaged spark plug (with the wrench-engaging member, insulator and electrical connector end broken off) inserted into the alternate embodiment of the present invention as shown in FIG. 2A;

FIG. 4B is an exploded perspective view of the view of FIG. 4A, showing the thread indentations on the body of the spark plug;

FIG. 5 is an enlarged front view of a damaged spark plug (showing a missing wrench-engaging member in phantom), showing spline indentations formed by an embodiment of the present invention; and

FIG. 6 is an enlarged front view of a damaged spark plug (showing a missing wrench-engaging member in phantom), showing thread indentations formed by an alternate embodiment of the present invention.

### DETAILED DESCRIPTION OF THE EMBODIMENTS

The present invention substantially simplifies the potentially burdensome task of removing a damaged spark/glow plug from a cylinder head (not shown) in an engine (not shown). The present invention provides a simple and effective means to remove a damaged spark plug from a cylinder head without having to remove the cylinder head from the engine.

In particular, embodiments of the tool of the present invention facilitate the removal of a spark/glow plug from a cylinder head when the wrench-engaging member (generally a hex member) on the outside of the spark plug has been damaged or broken off altogether, and the plug is no longer removable with standard tools.

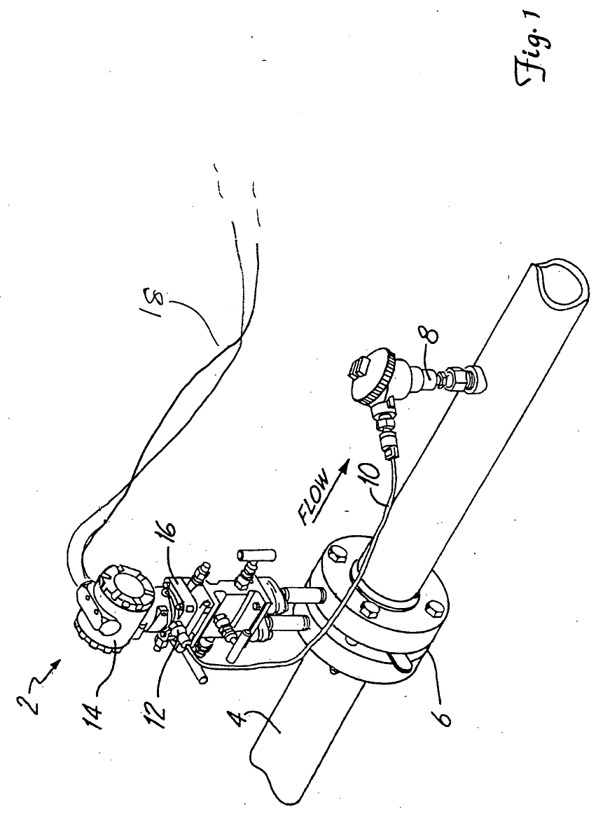

Referring now to FIGS. 1A and 1B, the tool of the present invention is designated generally as 10. The tool 10 is adapted to matingly engage a spark plug 11, including one having a damaged or missing wrench-engaging member 32 (see FIGS. 5 and 6). It is also contemplated as being within the purview of the present invention that the tool 10 (as well as tool 10′) is equally useful for removing glow plugs (not shown), including those that are broken or damaged, from an engine.

A spark/glow plug 11, 11′ has an electrode end 26 and an electrical connector end 28. Adjacent to the electrical connector end 28 is an insulator 30, and the wrench-engaging member 32. The spark/glow plug 11, 11′ further includes a body 34 adjacent to the wrench-engaging member 32, the body 34 having a reduced diameter D from the wrench-engaging member 32 width-across-corners diameter W. Adjacent to the body 34 is a threaded region 36, followed by the electrode end 26.

A plug 11, 11′ is installed into an engine with the electrode end 26 inserted into the associated orifice in the engine and the threaded region 36 matingly engaged within the engine. The body 34, wrench-engaging member 32, insulator 30, and electrical connector end 28 remain generally visible when the plug 11, 11′ is installed in the engine. Often, if a plug 11, 11′ fractures after prolonged service at high temperature, it occurs at or near the point where the body 34 adjoins the wrench-engaging member 32. The plug 11, 11′ may be more likely to break at this location than others because the diameter of the material at this point tends to be somewhat thinner than at other points on the plug 11, 11′, and the repeated (over prolonged periods of time) heating and cooling of the material may cause it to be relatively more prone to breaking. A fracture at this location may leave only the body 34 of the plug 11, 11′ exposed.

The interior surface of the plug-receiving end 12 of the tool is equipped with splines 16 with sharp apexes 18. Referring now to FIGS. 3A and 3B, to remove a plug 11, the tool 10 is driven onto the body 34 (for example, by light hammer blows) of the broken plug 11, the force causing the apexes 18 to cut into the plug's body 34 and create a new gripping surface 24. Once the tool 10 is driven onto the body 34, a rotational force may be applied to the wrench-engaging end 14 of tool 10 (which end 14 is opposed to plug receiving end 12) in a manner to unscrew the plug 11 from the engine. This spline 16 and apex 18 design requires minimal energy to form and engage the body 34 of the spark plug 11 with the tool 10. The new gripping surface 24 will withstand up to about 75-80 foot pounds of torque after proper installation.

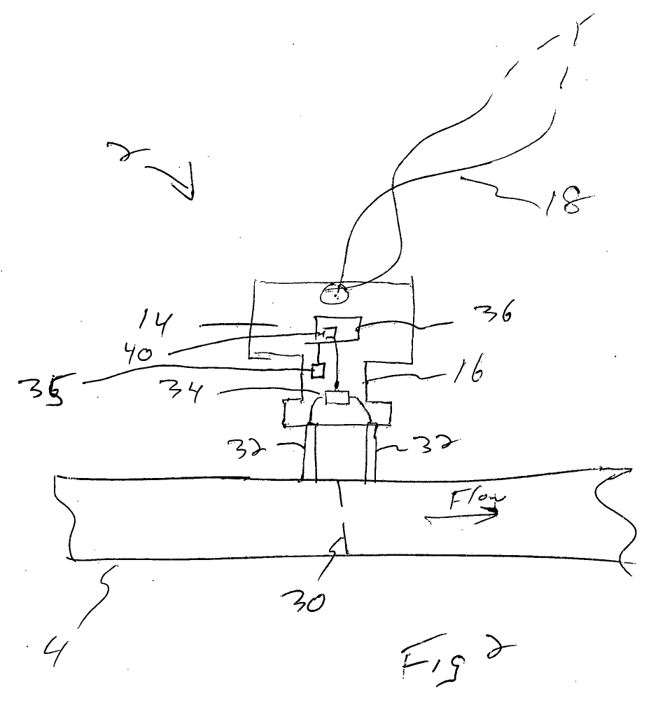

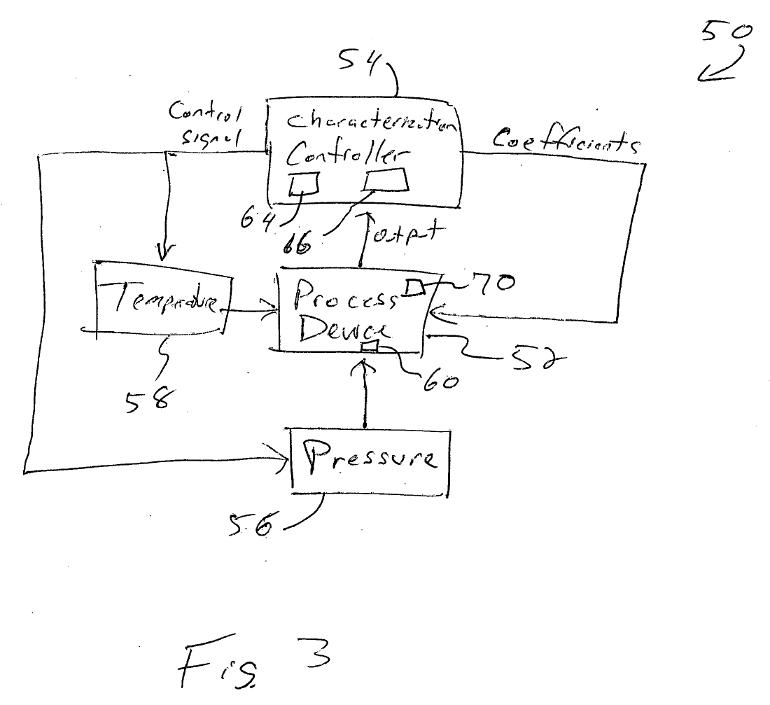

In an alternate embodiment, the interior surface of the plug-receiving end 12′ of the tool 10′ is equipped with reverse threading 22 (e.g. left-hand thread) with sharp ribs 38, as shown in FIGS. 2A and 2B. Referring now to FIGS. 4A and 4B, to remove a plug 11′, the tool 10′ is rotationally driven onto the broken plug 11′ to force the ribs 38 to cut into the body 34 of the plug 11′ and create a new gripping surface 24′. The interior surface may also be equipped with one or more flutes 40 to allow space for material removed from the body 34 when the tool 10′ is driven onto it. Once the tool 10′ is driven onto the body 34, a rotational force may be applied to the wrench-engaging end 14′ of tool 10′ (which end 14′ is opposed to plug receiving end 12′) in a manner to unscrew the plug 11′ from the engine. It is also contemplated and foreseeable that the interior surface of the plug-receiving end 12′ of this alternate embodiment of the tool 10′ may be equipped with standard, rather than reverse threading 22 to accommodate plugs 11′ which may have reverse (rather than standard) threading 36.

It is to be understood that the wrench-engaging end 14, 14′ of tool 10, 10′ is adapted to receive a torque-delivering member (not shown), such as, but not limited to, a socket wrench (hand or pneumatic driven), box wrench, open end wrench, crow's foot, or the like. The wrench-engaging end 14, 14′ may be formed in any shape, such as flats, sockets, or the like, adapted to receive a torque-delivering member, such as, but not limited to, hexagonal, square, or the like.

The relatively small size and/or shape of the tool 10, 10′ allows the tool 10, 10′ to be utilized in areas of relatively low tool clearance, such as is common with installed spark/glow plugs 11, 11′. In addition, the tool 10 may be made in various sizes to adapt to the confined spaces encountered in various cylinder head/spark (and/or glow) plug configurations. It is also contemplated and foreseeable that tools 10, 10′ of various sizes and/or shapes may be assembled and sold as a kit. Such a kit may be particularly useful to one who regularly works on a variety of cars, such as a professional auto mechanic, or the like.

The external grip design of the tool 10, 10′ may advantageously reduce the possibility that a broken insulator 30, or other broken parts of the plug 11, 11′ will be pushed into the combustion chamber of an engine during removal of a spark plug.

It is to be understood that tool 10, 10′ may be formed from any suitable material(s) and by any suitable method(s).

While several embodiments of the invention have been described in detail, it will be apparent to those skilled in the art that the disclosed embodiments may be modified. Therefore, the foregoing description is to be considered exemplary rather than limiting, and the true scope of the invention is that defined in the following claims.

1. A tool for removing a damaged spark plug, the damaged spark plug having an electrode end, an electrical connector end, an insulator therebetween, a damaged wrench-engaging member having a pre-damaged disposed about the insulator end, and a body depending away from the damaged wrench-engaging member by the body having a periphery smaller than a periphery of an undamaged the wrench-engaging member width-across-corners diameter, the tool comprising:
a body portion extending along a first direction, the body portion having a first end, a second end, and an aperture extending from the first end into the body portion toward the second end, the aperture defining an interior surface configured to engage a portion of the body of the damaged spark plug adjacent the damaged wrench-engaging member for rotating and removing the damaged spark plug, wherein a length of the aperture in the first direction is greater than or equal to a distance from the electrical connector end to the damaged wrench-engaging member.

2-16. (canceled).

17. The tool of claim 1, wherein the interior surface has a threaded portion.

18. The tool of claim 17, wherein a first thread direction of the threaded portion is opposite a second thread direction of a threaded portion of the spark plug proximate the electrode end.

19. The tool of claim 18, wherein the threaded portion further has at least one groove.

20. The tool of claim 1, wherein the interior surface further has at least one spline portion.

21. The tool of claim 1, wherein the second end is configured to receive a torque application device.

22. A method of removing a damaged spark plug from an engine utilizing a tool, the damaged spark plug having a damaged wrench-engaging member and a body disposed adjacent the wrench-engaging member, the tool having a body portion extending along a first direction, the body portion having a first end, a second end, and an aperture extending from the first end into the body portion toward the second end, the aperture defining an interior surface configured to engage a portion of the body of the damaged spark plug adjacent the damaged wrench-engaging member, the method comprising:
disposing the tool proximate the spark plug such that the interior surface of the tool contacts the body of the damaged spark plug adjacent the damaged wrench-engaging member;
connecting a torque application device to the second end of the tool; and
rotating the torque application device in a first direction to rotate the tool and the damaged spark plug to remove the damaged spark plug from the engine.

23. The method of claim 22, further comprising:
rotating the torque application device in a second direction opposite the first direction to further engage the interior surface of the tool into an exterior surface of the body of the damaged spark plug.
